(19) United States
(12) Patent Application Publication
(10) Pub. No.: US 2009/0056572 A1
(43) Pub. Date: Mar. 5, 2009

(54) TURNER BAR ASSEMBLY OF A WEB-FED PRINTING PRESS

(75) Inventor: Stefan Menzinger, Dasing (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/199,188

(22) Filed: Aug. 27, 2008

(30) Foreign Application Priority Data
Aug. 29, 2007 (DE) 10 2007 040 678.0

(51) Int. Cl. B41F 13/54

(52) U.S. Cl. 101/228

(57) ABSTRACT

A turner bar assembly of a web-fed printing press is disclosed. The turner bar assembly includes at least one turner bar, which is mounted so that it is translatorily movable on a linear guide and can be acted upon with blast air. The blast air flows through the linear guide in such a way that the blast air can be conveyed to the respective turner bar via the linear guide.

This application claims the priority of German Patent Document No. 10 2007 040 678.0, filed Aug. 29, 2007, the disclosure of which is expressly incorporated by reference herein.

### BACKGROUND AND SUMMARY OF THE INVENTION

The invention relates to a turner bar assembly of a web-fed printing press.

In a web-fed printing press, a web-shaped printing substrate, which is kept in readiness on a reel changer in the form of a printing substrate roll, is moved through several printing units for printing. Starting from the printing units, the printed, web-shaped printing substrate is conveyed to a folding unit in order to separate copies from the web-shaped printing substrate by cross-cutting and to form at least one longitudinal fold and/or at least one cross-fold on the copies. Viewed in the transport direction of the web-shaped printing substrate, a so-called turner bar nest, which is comprised of at least one turner bar assembly, is positioned downstream from the printing units and upstream from the folding unit. The printed, web-shaped printing substrate or the partial webs formed by longitudinal cutting of the printing substrate can be turned in the region of the turner bar nest.

A turner bar assembly has at least one turner bar, which is mounted so that it is translatorily movable on a linear guide. The, or each, turner bar of a turner bar assembly can be acted upon by blast air in order to build up an air cushion between the respective turner bar and the printing substrate web that is to be turned. In the case of turner bar assemblies known from practice, the blast air is conveyed to the respective turner bar via a flexible hose which is kept in readiness, e.g., in the form of a hose reel, wherein, depending upon the distance of the respective turner bar to the hose reel, the hose is unwound by the hose reel or wound onto the hose reel.

These types of hoses that are wound up in the form hose reels for supplying the respective turner bar with blast air take up a relatively large amount of construction space and obstruct access to the respective turner bar.

Starting herefrom, the present invention is based on the objective of creating a novel turner bar assembly of a web-fed printing press. According to the invention, blast air flows through the linear guide in such a way that the blast air can be conveyed to the respective turner bar via the linear guide.

Within the scope of the present invention, it is provided for the first time that blast air that is to be conveyed to a turner bar be conveyed to the turner bar via the linear guide, on which the turner bar is mounted so that it is translatorily movable. This also makes it possible to dispense with the hose reels that are required according to practice, on which either a flexible hose is wound or from which a flexible hose is unwound. As a result, construction space can be saved. In addition, the turner bars are more accessible.

The turner bar preferably engages on a guide carriage and is mounted so that it is translatorily movable via the guide carriage on the linear guide, wherein the blast air can be conveyed to the turner bar via the linear guide and via the guide carriage.

According to a preferred development of the invention, the guide carriage and therefore the turner bar is mounted so that it is translatorily movable via a belt drive on the linear guide, wherein a toothed belt of the belt drive, on the one hand, serves as the drive of the guide carriage and therefore of the turner bar and, on the other hand, as the inward and/or outward seal of the linear guide.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 is a schematic section of an inventive turner bar assembly of a web-fed printing press according to a first exemplary embodiment of the invention; and

FIG. 2 is a schematic section of an inventive turner bar assembly of a web-fed printing press according to a second exemplary embodiment of the invention.

### DETAILED DESCRIPTION OF THE DRAWINGS

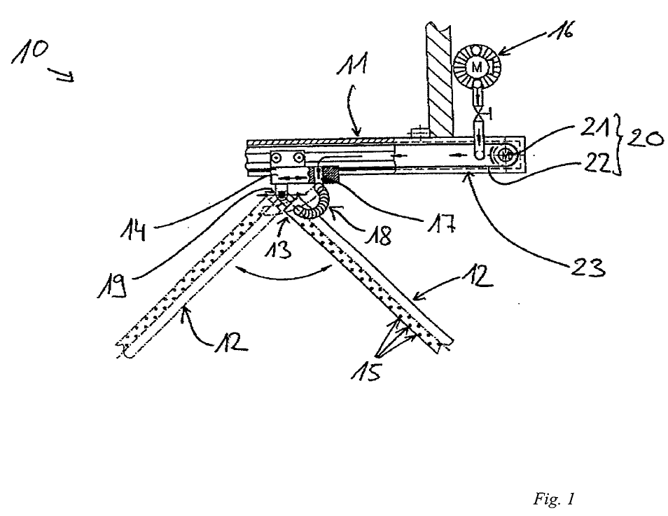

FIG. 1 shows a schematic representation of an inventive turner bar assembly 10 according to a first exemplary embodiment of the present invention, wherein the turner bar assembly 10 is comprised of a turner bar 12 that is translatorily movable on a linear guide 11. One end 13 of the turner bar 12 is pivoted on a guide carriage 14, wherein the guide carriage 14 and therefore the turner bar 12 is mounted so that it is translatorily movable on the linear guide 11. FIG. 1 shows the turner bar 12 in two different pivot positions. The turner bar 12 has several openings 15 for blast air on its surface, through which the blast air, which is made available to the respective turner bar 12 with the aid of a blower 16, can flow out of the turner bar 12 in order to provide an air cushion between the turner bar 12 and the printing substrate web being turned on the turner bar.

Within the scope of the present invention, the blast air being made available by the blower 16 to the turner bar 12 is conveyed via the linear guide 11. Consequently, blast air flows through the linear guide 11, wherein the blast air is conveyed to the turner bar 12 via the guide carriage 14 starting from the linear guide 11.

For this purpose, a bore hole 17 is introduced into the guide carriage 14, through which blast air can escape from the linear guide 11 and be conveyed to the turner bar 12.

In the exemplary embodiment depicted in FIG. 1, a flexible hose 18 extends between the guide carriage 14 and the turner bar 12, which, on the one hand, engages on the bore hole 17 of the guide carriage 14 and, on the other hand, on the turner bar 12 in order to thereby convey the blast air to the turner bar 12 starting from the guide carriage 14.

In contrast to this, it is also possible to convey blast air to the turner bar 12 via a joint 19, via which the turner bar 12 is pivoted on the guide carriage 14. In this case, the flexible hose 18 can be dispensed with.

In the exemplary embodiment depicted in FIG. 1, the guide carriage 14 and therefore the turner bar 12 is mounted so that it is translatorily movable on the linear guide 11 via a belt drive 20, wherein the belt drive 20 is comprised of a toothed belt 22 driven by a motor 21. The toothed belt 22 does not just serve to drive the guide carriage 14 and therefore the turner bar 12, rather the toothed belt 22 also serves to seal the linear guide 11 inwardly and outwardly. This makes it possible to prevent contamination from getting into the interior space of the linear guide 11 from the outside. In addition, it is possible to prevent blast air made available by the blower 16 from exiting to the outside from the interior space of the linear guide 11 in an uncontrolled manner.

The toothed belt 22 of the belt drive 20 is guided in a groove 23 of the linear guide 11 on both sides so that the above-mentioned sealing function can be guaranteed.

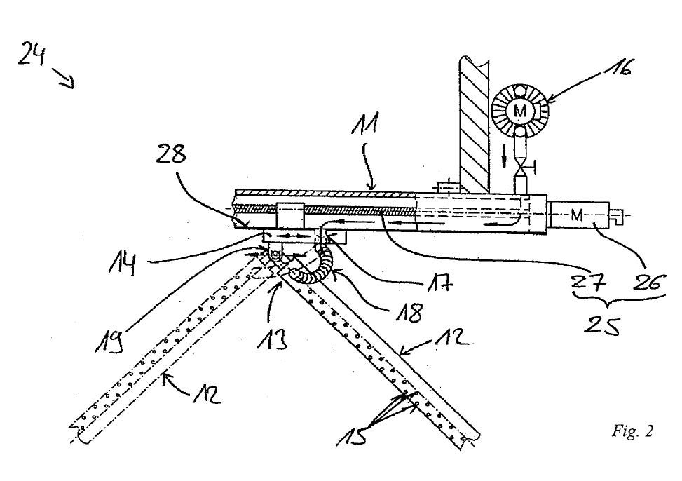

FIG. 2 shows a second exemplary embodiment of an inventive turner bar assembly 24, wherein the following will discuss only the details of the exemplary embodiment in FIG. 2 that differ from those of the exemplary embodiment in FIG. 1. As a result, in order to avoid unnecessary repetition, the same reference numbers are used for the same components and reference is made to the foregoing statements with respect to these details.

In the exemplary embodiment in FIG. 2, the guide carriage 14 and therefore the turner bar 12 is mounted so that it is translatorily movable on the linear guide 11 via a threaded spindle drive or a recirculating ball screw drive 25, wherein the threaded spindle drive or the recirculating ball screw drive 25 is comprised of a threaded spindle or recirculating ball screw 27 that can be driven by a motor 26. In contrast to the belt drive 20, the threaded spindle drive or the recirculating ball screw drive 25 is used exclusively for the translatory displacement of the turner bar 12 along the linear guide 11. In the exemplary embodiment in FIG. 2, a cover band 28 seals the linear guide 11 through which blast air is flowing, and it seals the linear guide 11 inwardly and outwardly.

### LIST OF REFERENCE NUMBERS

10 Turner bar assembly
11 Linear guide
12 Turner bar
13 End
14 Guide carriage
15 Opening
16 Blower
17 Bore hole
18 Hose
19 Joint
20 Belt drive
21 Motor
22 Toothed belt
23 Groove
24 Turner bar assembly
25 Threaded spindle drive or recirculating ball screw drive
26 Motor
27 Threaded spindle or recirculating ball screw
28 Cover band

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A turner bar assembly of a web-fed printing press, comprising a turner bar, which is mounted such that the turner bar is translatorily movable on a linear guide and is acted upon with blast air, wherein the blast air flows through the linear guide such that the blast air is conveyed to the turner bar via the linear guide.

2. The turner bar assembly according to claim 1, wherein the turner bar engages on a guide carriage and is mounted so such that the turner bar is translatorily movable via the guide carriage on the linear guide and wherein the blast air is conveyed to the turner bar via the linear guide and via the guide carriage.

3. The turner bar assembly according to claim 2, wherein the turner bar is pivoted on the guide carriage via a joint and wherein the blast air is conveyed to the turner bar starting from the guide carriage via a flexible hose extending between the guide carriage and the turner bar.

4. The turner bar assembly according to claim 2, wherein the turner bar is pivoted on the guide carriage via a joint and wherein the blast air is conveyed to the turner bar starting from the guide carriage via the joint.

5. The turner bar assembly according to claim 2, wherein the guide carriage, and therefore the turner bar, is mounted such that the guide carriage is translatorily movable on the linear guide via a belt drive.

6. The turner bar assembly according to claim 5, wherein a toothed belt of the belt drive serves as a drive of the guide carriage and as an inward and/or an outward seal of the linear guide.

7. The turner bar assembly according to claim 6, wherein the toothed belt of the belt drive is guided in a groove of the linear guide.

8. The turner bar assembly according to claim 2, wherein the guide carriage, and therefore the turner bar, is mounted such that the guide carriage is translatorily movable on the linear guide via a threaded spindle drive or a recirculating ball screw drive.

9. The turner bar assembly according to claim 8, wherein a cover band serves as an inward and/or an outward seal of the linear guide.

10. A turner bar assembly of a web-fed printing press, comprising:
a turner bar;
a linear guide, wherein the turner bar is mounted on the linear guide such that the turner bar is translatorily movable on the linear guide; and
an air blower coupled to the linear guide, wherein blast air from the air blower is provided to the turner bar through the linear guide.

11. The turner bar assembly according to claim 10, further comprising an air seal associated with the linear guide.

12. The turner bar assembly according to claim 11, wherein the air seal is a drivable toothed belt.

13. The turner bar assembly according to claim 12, wherein the drivable toothed belt is disposed within a groove of the linear guide.

14. The turner bar assembly according to claim 11, wherein the air seal is a cover band.

15. The turner bar assembly according to claim 10, wherein the blast air from the air blower is provided to the turner bar through the linear guide via a hose coupled between the linear guide and the turner bar.

16. The turner bar assembly according to claim 10, wherein the blast air from the air blower is provided to the turner bar through the linear guide via a joint which pivotally couples the turner bar to the linear guide.
